(19) United States
(12) Patent Application Publication
(10) Pub. No.: US 2003/0088497 A1
(43) Pub. Date: May 8, 2003

(54) Combination currency/barter system

(76) Inventor: Eduardo J. Belgrano, San Antonio, TX (US)

Correspondence Address: Cline H. White, JACKSON WALKER, LLP, Suite 2100, 112 E. Pecan, San Antonio, TX, 78205, US

(21) Appl. No.: 10/004,243

(22) Filed: Nov. 2, 2001

(51) Int. Cl. G06F 17/60

(52) U.S. Cl. 705/37

(57) ABSTRACT

Conventional product exchange systems, where products can include both goods and services, include currency systems, and barter systems. The present invention combines barter systems and currency systems, allowing participants to exchange goods and services with the goods and services of others in the network. The network is a closed market, with participants offering goods and services with defined values in “trade dollars.” After a designated time period, each barter transaction made by a participant with another participant in the network is settled. Where there are both purchases and sales, the amount that is equal is referred to as the “offset.” The unequal amount is referred to as a balance, either positive or negative. If a participant's balance is positive, reflecting that particular participant has provided more value in goods and services than the participant has received, the participant is paid an amount of currency equal to the balance, less a fee. If the balance is negative, reflecting that the participant received more value in goods or services than the participant provided, the participant is debited for an amount equal to the negative balance.

### BACKGROUND OF THE INVENTION

1. Field of the Invention

Applicant's invention relates to a method for combining barter systems and currency systems. More particularly, it relates to a system whereby a network of individuals and small business concerns (not necessarily limited to small businesses) can exchange goods and services with the goods and services of others in the network, while having the ability to finance negative balances and receiving currency for positive balances.

2. Background Information

Conventional product exchange systems, where products can include both goods and services, include currency systems, and barter systems. Originally, barter systems allowed participants to trade one's products for another's products. In the classic barter system, a herdsman could, for example, give meat or hides in exchange for tools produced by a craftsman or the services of a healer. The problem tended to be that the barterers needed to find someone to barter with that had the product they wanted and who wanted their product. If a person had arrowheads to trade and wanted potatoes, they not only had to find someone with potatoes, but someone with potatoes that wanted arrowheads. As civilization evolved and trade became more complex, society found it more efficient to use a common medium of exchange. The chosen mediums of exchange have included a range of goods and objects, including gold and silver, but has generally come to be currency. Currency, of course, allows participants to trade their products for set values of the currency, the currency can then be re exchanged for other products. Modern barter systems often use an accounting entry, for example the trade dollar (designated “T$”), as a common medium of exchange and to track transactions. The trade dollar can be valued so as to create a common exchange rate across borders where differing currencies are employed. While the currency system has evolved to become the dominant system, both the currency and the barter systems have been continued in use to date.

Both of the exchange systems have advantages and disadvantages. The currency exchange system has become dominant because of its advantages in allowing its participants to exchange their products for currency, then exchange their currency for other products at a different time and place. Thus, currency allows for portability. On a mundane level, this portability allows participants to go through daily business as well as travel while carrying currency for the purpose of obtaining needed goods or services. In this manner, a participant does not need to carry its goods or provide services every time another's product is required or desired. On a more complex level, currency itself can become a product for the purpose of financing loans and giving credit, as well as investing and many other modes. While this is not intended to detail the currency exchange system, nor list each of its benefits, it is clear that the virtues of the currency exchange system have made it predominant method of product exchange throughout the world.

The barter exchange system continues to survive despite the dominance of the currency exchange system. Because of the simplicity of the barter exchange system, it can be revived by participants under circumstances where the currency system has failed or where a simple barter system can provide more value for exchanged products.

Despite their co-existence, currency and barter exchange systems tend to be mutually exclusive. Barter originated due to the lack of a common mean of exchange (currency), and is reintroduced or reused due to that same lack of common currency exchange, or for the specific purpose of avoiding the use of currency. Thus, although a single participant can consummate transactions in both currency and barter exchanges, even to the point of combining a barter and currency into the same transaction, there is no common combined barter/currency exchange system available for a network of participants. This is due, at least in part, to the fact that the two exchange systems act to exclude one another. The currency system is based on the use of currency, while the barter system purposefully excludes currency. Because both the currency and the barter exchange system enjoy very specific attributes and advantages, it would be advantageous to combine the systems in a systematic manner that takes advantage of each system's benefits. Further, it would be advantageous if such a combination system were to provide benefits to all participants to the system including buyers and sellers, as well as financial institutions and other economic entities.

### SUMMARY OF THE INVENTION

The present invention is a currency/barter system wherein system participants barter their goods and services for the goods and services of other participants in the networks. The system further provides that the provided goods and services may specify a defined value in “trade dollars” (“T$”) which are the units used to quantify the value of goods and services within the system. It is anticipated that one trade dollar will be valued at one U.S. dollar (T$1=$1), but any consistent valuation could be set. After a designated time period, generally a month, each barter transaction made by a participant with another participant in the network, referred to as a qualified transaction is settled, or totaled. “Sales” result in a positive balance of trade dollars, while “purchases” result in a negative balance of trade dollars. The designated time period total of qualified transactions will result in one of three possible scenarios: 1) the participant made more sales than purchases, 2) purchases and sales were even, or 3) the participant made more purchases than sales. Where there are both purchases and sales, the amount that is equal is referred to as the “offset.” The unequal amount is referred to as a balance, either positive or negative. For example, if a participant made purchases of T$500, and sales of T$400, then the offset would be T$400, while the participant would have a negative balance of T$100. If, after the designated time period, a participant's balance is positive, reflecting that particular participant has provided more value in goods and services than the participant has received, the participant is paid an amount of currency equal to the balance less the fee refunded to previous buyers. If the balance is negative, reflecting that the participant received more value in goods or services than the participant provided, the participant is debited for an amount equal to the negative balance.

The present invention is comprised of four types of entities: participants who are entities or persons that offer goods or services, credit institutions that provide financing to the participants, affiliates through who the present invention can be marketed, in part, to attract participants, and a system administrator that provides the structure and keeps track of qualified transactions and financing in participant, credit institution, and affiliate databases.

Participants become members of the network by having goods or service available to trade and being approved for financing by a credit institution. Once approved, the participant can commence trading immediately. Participants purchase goods and services from other network participants and these purchases are guaranteed by their approved line of credit from the credit institution. Within the network, participants can obtain goods or services, or provide goods or services. When a participant provides goods or services, they are credited with “trade dollars.” For a designated time period, generally a month, after the qualified transaction, the selling participant can use its trade dollars to obtain products from other network participants. After the designated time period, if the seller did not use the trade dollars, the participant will receive a credit in the participant's account for the equivalent in currency, which the participant may keep in the participant's account, and if so, will be added to the participant's credit line. Conversely, the participant may choose to withdraw in cash the sum credited, in which case, the participant is paid the value of the sale in currency, less the fee to be refunded. In order to finance the system, purchasing participants pay a fee on each transaction. However, the fee can be diminished or extinguished by the buying participant selling its own goods or services.

When a participant ends the designated time period with a negative balance, that amount is financed. However, it should be noted that the line of credit extended to the participant by the credit institution guarantees the solvency of the participant to make qualified transaction purchases up to the value of the line of credit. Once a qualified transaction purchase is made, the selling participant “finances” the sale because the seller receives trade dollars. At the end of the designated time period, participants are billed for negative balances. If the participant pays off the negative balance, then there is no further financing. If the participant does not pay off the negative balance, then the credit institution finances the qualified transaction by paying the negative balance to the selling participant (who may not be the participant who originally sold the buyer, the product. This is due to the great number of interrelated transactions). In this manner, risk to the selling participants is virtually eliminated because they will receive payment from either the buying participant or the credit institution, and risk to the credit institution is reduced because the credit institution does no financing during the designated time period, and after that, only on the negative balance portion of the qualified transaction amount, not the total or offset amount.

While the present invention is not intended to be exclusively controlled by computer programs or algorithms on the Internet, it is intended that the present invention can be mostly implemented and controlled by computer programs or algorithms over the Internet by the system administrator. Therefore, the present invention contemplates a series of computer algorithms and method by which the present invention is implemented and controlled. Thus, in some of the descriptions herein, the present invention is presented partly in terms of process steps and operations of data bits within a computer memory. An algorithm is here, and generally, conceived to be a self-consistent sequence of steps leading to a desired result. These steps are those requiring physical manipulations of physical quantities. In the present invention, the operations referred to may be automated, machine operations done by a computer or similar device performed in conjunction with a human operator. The present invention relates to the methods for operating such devices, and processing electrical, magnetic, optic, or other physical signals to generate other desired physical signals. It further relates to a computer program and the control logic contained therein. The present invention also relates to apparatus for performing these operations. The apparatus may be specially constructed for the required purposes or it may comprise a general purpose computer selectively controlled or reconfigured by a computer program stored in the memory of the computer. Further, because the present invention is intended to include a network of participants, with no geographic limitations, it is contemplated that to better implement the system of the current invention, at least part of such implementation will take place on the Internet. The method presented herein is not inherently related to any particular computer or other apparatus. Similarly, no particular computer programming language is required. The required structure, although not machine specific, will be apparent from the description herein.

The present invention provides a novel system that will combine the positive aspects of currency exchange and barter exchange. With the system of the present invention, products are exchanged for trade dollars equal to the value of the product. The trade dollars can then be exchanged for other products effecting a barter exchange. However, if the qualified transaction involving barter exchange are not equivalent to each other, then an difference is calculated and referred to as a balance. The balance is then paid to the participant if the balance is positive, or debited to the participant for payment if the balance is negative.

The present invention further provides:

a. A method to help conserve the participant's cash. Participants can obtain desired goods or services in exchange for their own goods or services without using their cash on hand, thus, reserving such cash for non-qualified transactions;

b. A barter exchange system in which the participants also have currency available;

c. An increased market for participants' goods and services by making the participant a member of a network comprised of a number of participants. Because the network acts as a closed economy, or market, participants within the network will have increased demand for their goods and services;

d. A system in which participants can obtain goods and services without using currency, but because they are also providing goods and services, will not be required to pay the full amount of the obtained goods and services at the end of the given period, provided that purchases were totally or partially offset with sales by the same participant;

e. A method for decreasing carried debt by the network participants;

f. A system wherein participants are granted a line of credit for the obtaining of network goods and services, thus, improving the attractiveness of participant goods and services to one another. In this manner, buyer loyalty within the network is increased;

g. A system that allows individuals with goods or skills to be able to obtain necessary goods and services despite a lack of currency;

h. A system which involves credit institutions in the financing of bartering transactions; and

i. A way for participants to cross over to the formal economy ruled by currency, through the payback feature.

Although, as discussed above, barter is not new and “trade dollars” are not a new concept, the combination of barter, trade dollars and eventual payment with currency is a unique combination of barter exchange and currency exchange. The present invention creates an artificially closed economy or market in the form of a business network of participants who each provide goods or services by exercising a trade or profession. The credit institutions provide credit lines which empower the participants of the network to purchase goods and services using the barter exchange system by guaranteeing the financing of the negative balances after settlement is made at the end of the designated time period, but providing one hundred percent liquidity after a designated time period from the qualified transaction less a fee. The fee can be refunded and can be as little as $0.00. Thusly, a selling participant can recoup the cash value of its goods or services, but a buying participant can obtain goods and services without an immediately outlay of currency.

In order to create a disincentive to participants from withdrawing positive balance in cash, it is anticipated that those who choose to do so will be charged a fee. This fee could be payable to the system administrator, credit institutions, or other participants who previously purchased from the first participant. However, this does not mean necessarily that only the previous participant buying might receive the refund. It is envisioned the present invention provides for the participant withdrawing the cash to pay, for example, 8.5% to the previous buyers. This will be effectively a refund of the fees all these buyers paid when they bought from the participant withdrawing the money. In order for the buyers not to receive a refund bigger than the fee they originally paid, the number of buyers receiving the refund will be determined by the size of the refund. The amount to be refunded would be compared to the fee the immediate previous buyer paid. If the refund is bigger, a second immediate buyer's fee paid will be compared, and so on, until the refund is paid out to buyers, who will receive a portion of the refund, which will be equal or smaller to the fee each paid when making the purchase. If the amount to be refunded is equal or smaller to the fee paid by the immediate previous buyer, then he or she alone will receive the total refund. This mechanism is thought out this way, to prevent buyers from colluding between themselves with the objective of receiving a refunded amount, bigger than the fee they paid when making the purchase.

In the closed market created by the present invention, the participants act as both the sellers of goods and services, and the buyers of goods and services at the same time. In order to attract participants to join the network, it is anticipated that the system of the present invention would be co-branded with various associates. The associates sought would be companies, trade associations, guilds, and the like whose members would have products available and attractive for barter within the system network.

As a disincentive to participants with positive balances from not purchasing within the system and simply cashing out, the system administrator may choose to charge a commission, otherwise charged to the buyers at the time of purchase, to be refunded to the buyers.

### BRIEF DESCRIPTION OF THE DRAWINGS

FIG. 1. describes the relationship of the entities in the present invention.

FIG. 2. describes the mechanics of operations between the entities in the present invention.

FIG. 3. describes the flow of interactions in the present invention.

FIG. 4A. illustrates an example of qualified transactions between participants in the present invention.

FIG. 4B. is a table based upon the example transactions of FIG. 4A. showing the calculations in the present invention.

### DETAILED DESCRIPTION OF THE PREFERRED EMBODIMENT

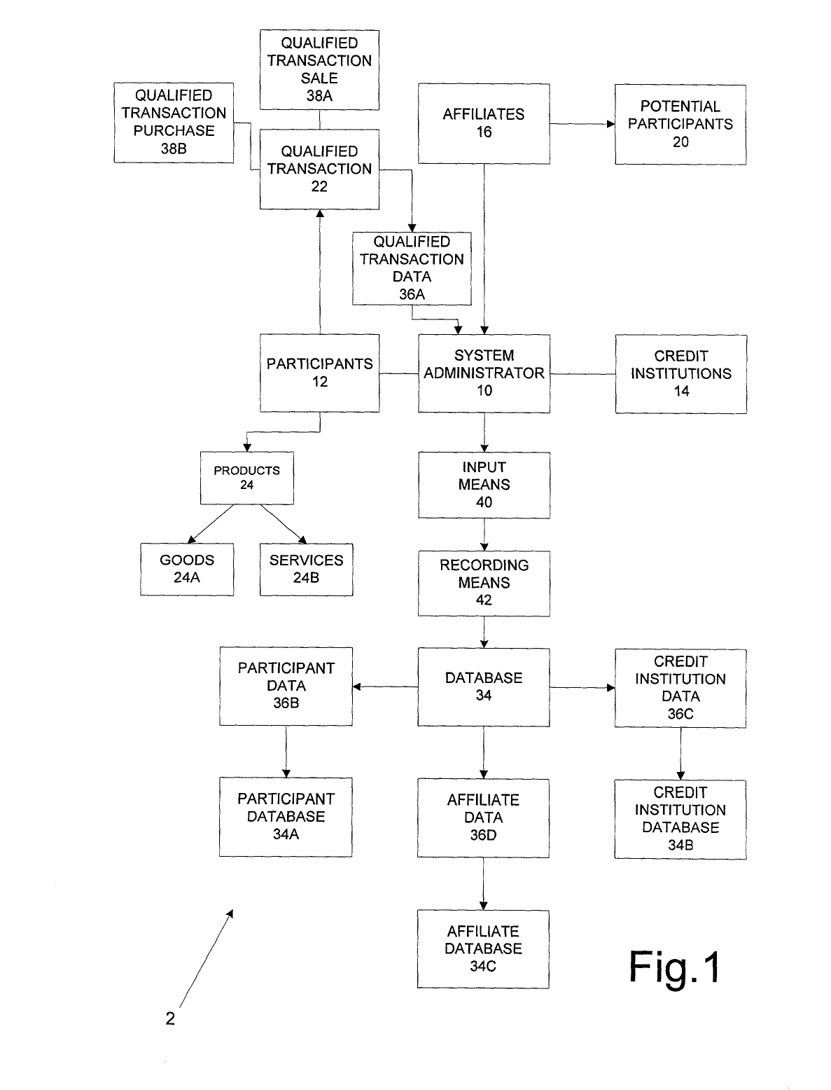

Referring to the figures, FIG. 1. illustrates the relationships between the entities within the present invention. The currency/barter system (2) is made up of the system administrator (10), the participants (12), the credit institutions (14) and the affiliates (16). The system administrator (10) acts to maintain databases (34) for storage of qualified transaction data (36A). It further stores participant data (36B), credit institution data (36C), and affiliate data (36D). The system administrator (10) gathers relevant qualified transaction data (36A), participant data (36B), and credit institution data (36C) through an input means (40) and records same via a recording means (42) in the database (34).

The participants (12) are accepted into the currency/barter system (2), in part, due to their having products (24) available. Products (24) can take the form of either goods (24A) or services (24B). Participants (12) can enter into qualified transactions (22), qualified transaction sales (38A) and qualified transaction purchases (38B), with other participants (12) within the currency/barter system (2). While potential participants (20) may come from anywhere, it is anticipated that the currency/barter system (2) will be co-branded with various affiliates (16). By co-branding the currency/barter system (2) with affiliates (16) who have existing networks of potential participants (20), it is more probable to obtain greater numbers of participants (12) within the currency/barter system, with less advertising and promotional efforts. The affiliates (16) are anticipated to be companies, trade associations, gilds, or like institutions whose members would have products (24) available for qualified transactions (22). Credit institutions (14) could also act as affiliates (16), providing financing as well as potential participants (20) from among their customers.

Finally, one or more credit institutions (14) would be recruited in order to provide lines of credit for the participants (12) and finance portions of qualified transactions (22). Any potential participant (20), prior to being accepted into the currency/barter system (2), would have to be approved by a credit institution (14) for a credit line. A participant (12) would not be allowed to make qualified transactions (22) wherein the participant's (12) credit line is exceeded by the value of the qualified transaction purchase (38B). The system administrator (10) is benefited by the currency/barter system (2) by receiving a fee on qualified transaction purchases (38B). Participants (12) are benefited by having a closed market within the currency/barter system (2) for the sale and purchase of products (24) plus total liquidity (in currency) for positive balances (28) (not shown). Credit institutions (14) are benefited by receiving interest payments on amounts financed (30) (not shown), receiving a fee on each qualified transaction (22), and low cost customer acquisition through the system administrator's (10) referrals mechanisms. Affiliates (16) are benefited by having a new closed market opened to their members and receiving a fee on each qualified transaction (22).

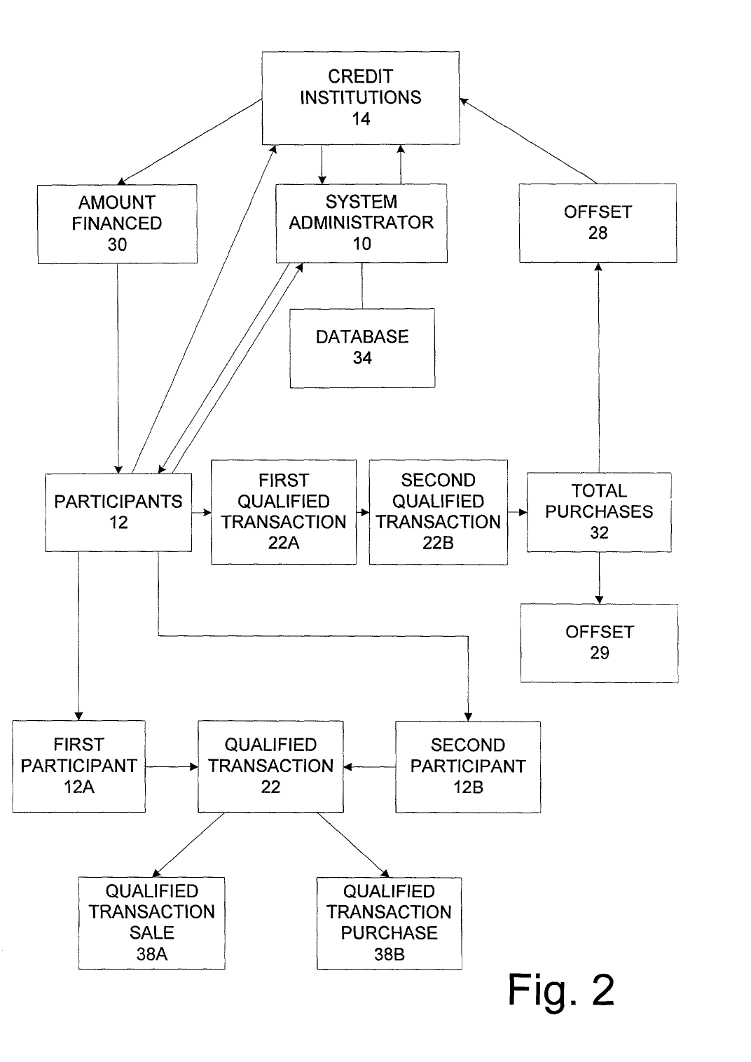

FIG. 2. illustrates the mechanics of operations between the entities within the currency/barter system (2). Credit institutions (14) guarantee negative balance (28) by providing the amount financed (30) for participants (12). The amounts financed (30) are equal to the balance (28) of the participant (12) if the balance (28) is a negative amount.

The system administrator (10) by virtue of its database (34) can provide regular feedback and information to the credit institutions (14) and the participants (12).

The participants (12) through the system administrator (10) make a credit request to the credit institution (14). The system administrator (10) prescreens and forwards the credit request to the credit institution (14) for approval or disproval. The credit institution (14) responds with appropriate credit approvals, cancellations, payments, etc., to the system administrator (10) who provides the participants (12) with updated information.

A first participant (12A) can enter into a qualified transaction (22) with a second participant (12B). For the first participant (12A) this qualified transaction (22) will either be a qualified transaction sale (38A) or a qualified transaction purchase (38B). Such qualified transactions (22) continue among the participants (12) such that there is a first qualified transaction (22A) and a second qualified transaction (22B).

Qualified transaction sales (38A) result in a positive amount and qualified transaction purchases result in a negative amount. Among all participants (12) the qualified transaction sales (38A) will equal qualified transaction purchases (38B), without accounting for fees, interest and the like. However, the first participant's (12A), qualified transaction sales (38A), and qualified transaction purchases (38B) may or may not be equal. The difference between the qualified transaction sales (38A) and the qualified transaction purchases (38B) is the first participant's (12A) balance (28). If the first participant's (12A) balance (28) is negative, indicating greater qualified transaction purchases (38B) than qualified transaction sales (38A), then the balance (28) is the amount financed (30).

The credit institution (14) and the system administrator (10) receive a fee on the total qualified transaction sales (38A). However, the amount financed (30) by the credit institution (14) is only equal to the balance (28) if the balance (28) amount is negative. Therefore, the credit institution (14) receives profit on the total purchases (32) but is only responsible for the amount financed (30), not the offset (29), making the amount financed (30) generally less than the total purchases (32).

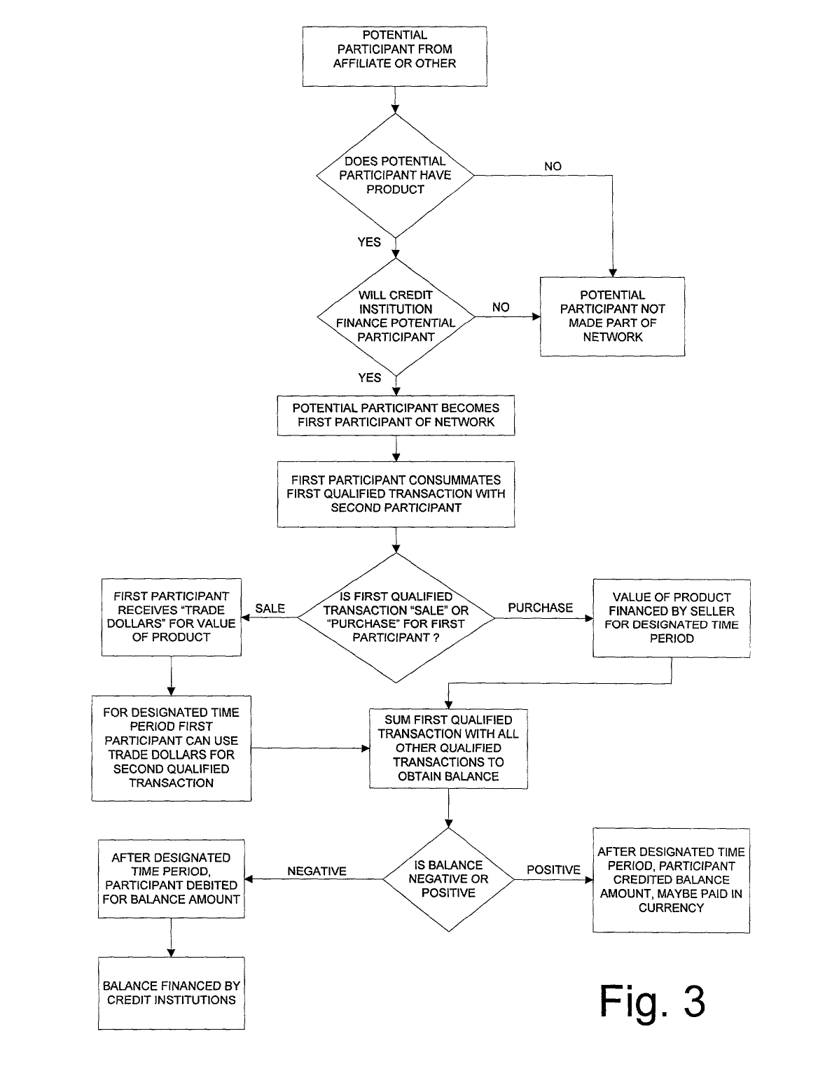

FIG. 3. illustrates the flow of interactions occurring within the currency/barter system (2). A potential participant (30) is obtained from an affiliate (16) or other source. The currency/barter system (2) then makes two inquiries regarding the potential participant (20). The first is whether or not the potential participant (20) has a product (24), either a good (24A) or a service (24B), that would be acceptable for qualified transactions (22) within the currency/barter system (2). If no, the potential participant (20) is not accepted as a member of the currency/barter system (2). If yes, then the potential participant (20) is submitted to a credit institution (14) for determination of whether the credit institution (14) will provide a line of credit to the potential participant (20). If no, then the potential participant (20) is not accepted as a member of the currency/barter system (2). If yes, the potential participant (20) becomes a first participant (12A) of the currency/barter system (2). The first participant (12A) is then free to make qualified transactions (22) within the currency/barter system (2).

The first participant (12A) consummates a first qualified transaction (22A) with a second participant (12B). The currency/barter system (2) determines whether the first qualified transaction (22A) is a qualified transaction sale (38A) or a qualified transaction purchase (38B) for each of the first participant (12A) and the second participant (12B). For the first participant (12A), if the first qualified transaction (22A) is a qualified transaction sale (38A), then the first participant (12A) receives a credit for an amount of trade dollars (23) equal to the value of the product (24). Although, due to promotional offers or marketing strategy, the first participant (12A) may receive less than the full value of the qualified transaction sale (38A), a small percentage of it being credited to the second participant (12B) to whom the first qualified transaction (22A) is a qualified transaction purchase (38B). This is intended to attract or lure buyers to the first participant's (12A) offer. For a designated time period (26) the first participant (12A) can use the trade dollars (23) received as a result of the qualified transaction sale (38A) for use in a second qualified transaction (22B). If the first qualified transaction (22A) is a qualified transaction purchase (38B) in regard to the second participant (12B), then the value of the product (24) is financed by the second participant (38B) during the designated time period (26).

After the designated time period (26), the first participant's (12A) qualified transactions (22) are summed, with qualified transaction sales (38A) being positive and qualified transaction purchases (38B) being negative. Where there are both qualified transaction sales (38A) and qualified transaction purchases (38B), the positive and negative amounts are summed. The amount that is cancelled is referred to as the offset (29), while the balance (28) is equal to the remaining amount. For example, if the first participant (12A) has qualified transactions (22) in a designated time period (26) with $500.00 in qualified transaction sales (38A) and $650.00 in qualified transaction purchases (38B), then the first participant's (12A) offset (29) would be $500.00 and the balance (28) would be negative <$150.00>. For all participants, the sum of all qualified transaction sales (38A) would be equal to the sum of all qualified transaction purchases (38B). The system administrator (10), under the currency/barter system (2), then determines whether the balance (28) is negative or positive. If negative, the second participant (12B) is debited for the balance amount (28), and the credit institution (14) will finance the negative balance (28), if any, of the second participant (12B). If its balance (28) is positive, the first participant (12A) is credited the amount of the balance (28). If the first participant (12A) chooses, it may withdraw its balance (28) in currency, however it is anticipated that the system administrator (10) may charge a fee for such withdrawals.

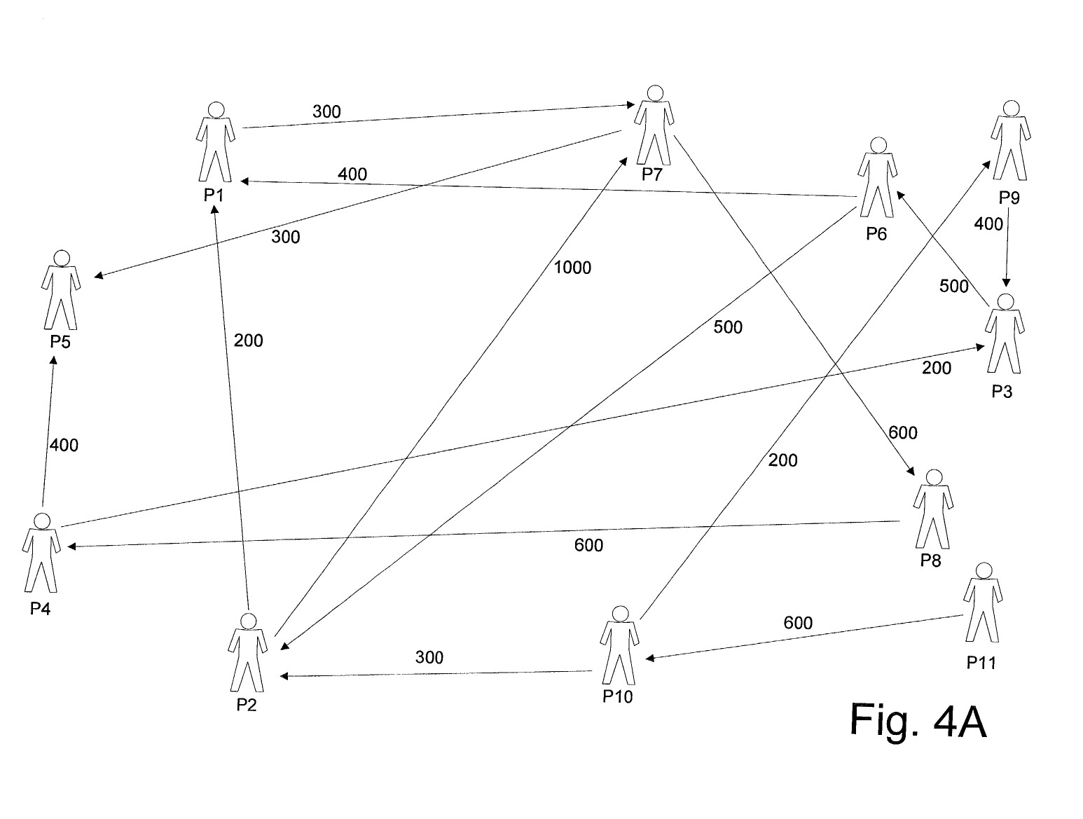

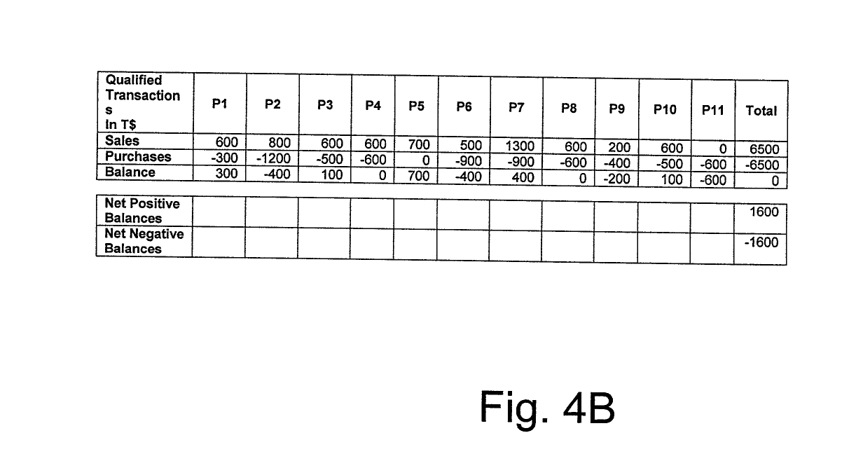

FIG. 4A. is an example of operation of the currency/barter system (2). It illustrates eleven participants (12) referred to as P1 through P11. Each of the participants (12) have engaged in one or more qualified transactions (22). Each qualified transaction (22) is represented by an arrow with the amount of the qualified transaction (22) printed along the arrow. In this example, the arrow points to the participant (12) to whom the qualified transaction (22) is a qualified transaction sale (38A). FIG. 4A. shows, in part, a first participant (12A) P-1 having made three qualified transactions (22): The first qualified transaction (22A) was a purchase (38B) in the amount of T$300 to a second participant (12B) P-7; the second qualified transaction (22B) was sale (38A) in the amount of T$400 from a third participant (12C) P-6; and the third qualified transaction (22C) was a sale (38A) in the amount of T$200 from a fourth participant (12D) P-2. Thus, the qualified transaction data (36A) for the first participant (12A) P-1 shows that the first participant (12A) P-1 had total qualified transaction purchases (38B) in the amount of T$300, and total qualified transaction sales (38A) in the amount of T$600. The qualified transaction data (36A) is received by an input means (40) and is stored via a recording means (42) in the database (34). The system (2) then uses a calculation means (44) to calculate that the first participant (12A) P-1's offset (29) and balance (28). The calculation means (44) would determine in this example that the first participant (12A) P1's offset (29) is T$300, and the first participant (12A) P1's balance (28) is positive (+)T$300. At the end of the designated time period (26), the first participant (12A) is credited a refund amount (31) if the first participant's (12A) balance (28) is positive. In the example above, P1's balance is positive (+)T$300, and P1 would therefore receive credit in the refund amount (31), which may be as much as the balance (28) or the balance (28) less a fee.

In contrast, a second example shows that P-2 made four qualified transactions (22): A qualified sale (38A) in the amount of T$300 from P-10; a qualified transaction sale (38A) in the amount of T$500 from P-6; a qualified transaction purchase (38B) in the amount of T$1,000 to P-7; and a qualified transaction purchase (38B) in the amount of T$200 to P-1. Therefore, P-2 had total qualified transaction purchases (38B) in the amount of T$1,200 and total qualified transaction sales (38A) in the amount of T$800 giving an offset (29) of T$800 and a balance (28) of negative T$400. Thus, P-2's amount financed (30) from the credit institution (14) would be negative T$400. At the end of the designated time period (26), P-2 would be debited in that amount. Additionally, P-2's total purchases (32) of T$1,200 would have a fee that would pay the system administrator (10).

FIG. 4B. is a table related to FIG. 4A. It shows total qualified transaction purchases (38B) and total qualified transaction sales (38A) for each of the participants (12) P-1 through P-11. It further shows that the qualified transaction sales (38A) for all of the participants (12) is equal to the total qualified transaction purchases (38B). Fees would be charged to the participants (12) on their qualified transaction purchases (38B). This fee, shown in FIG. 4B. by way of example only as 8.5%, would be split among the system administrator (10), credit institutions (14), and the affiliates (16). It further could be used to help pay participants for reimbursement of trade dollars (23) if their balances (28) are positive, or a cash back to participants (12) making qualified transaction purchases (38B).

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A currency/barter system for use in the exchange of products, said system comprising:
a database for storing qualified transaction data of said system;
an input means for receiving qualified transaction data reflecting qualified transactions made by a participant;
a recording means for storing said qualified transaction data in said database;
calculation means for determining a balance on said participant's qualified transactions during a designated time period, said calculation means carry out the operations for each participant of:
a) obtaining value of each qualified transaction;
b) calculating a sum of the values of all of said qualified transactions;
c) a balance being equal to said sum;
d) crediting said participant if said balance is positive; and
e) debiting said participant if said balance is negative.

2. The system of claim 1, wherein:
said qualified transactions are made by bartered goods/services;
said goods/services have a defined value;
said defined value is positive if said participant provides said goods/services;
said defined value is negative if said participant obtains said goods/services; and
said qualified transaction value being equal to said defined value.

3. The system of claim 1, wherein:
if said balance is negative, said credit institution finances said participant for an amount equal to said negative balance.

4. The system of claim 1, wherein:
said first participant is paid a refund amount if said balance is positive.

5. The system of claim 1, wherein:
said participant is one of a network of participants.

6. A currency/barter system for use in the exchange of products, said system comprising:
a first qualified transaction, wherein said first qualified transaction is a first participant and a second participant making said exchange of products;
a second qualified transaction, wherein said second qualified transaction is said first participant and a third participant making said exchange of products;
a database for storing qualified transaction data of said first and second qualified transactions;
an input means for receiving qualified transaction data;
a recording means for storing said qualified transaction data in said database;
calculation means for determining a balance on said first participant's first and second qualified transactions during a designated time period;
paying to said first participant a refund amount if said balance is positive.

7. A method in a computer system for controlling a currency/barter system for use in the exchange of products, the method comprising:
receiving qualified transaction data, wherein said qualified transaction data regards said exchange of products between a first participant and a second participant, and said first participant and said second participant are members of said currency/barter system;
storing said qualified transaction data in a database;
analyzing said qualified transaction data using a calculation means to determine a balance of said first participant's qualified transactions during a designated time period, wherein said balance is equal to the difference of said first participant's qualified transaction sales less said first participant's qualified transaction purchases;
calculating a refund amount if said balance is positive; and
outputting said refund amount.

8. In article of manufacture comprising:
A computer useable medium have computer readable program code means embodied therein for controlling a currency/barter system for use in the exchange of products, said computer readable program code means in said article of manufacture comprising:
computer readable program code means for causing receiving qualified transaction data;
computer readable program code means for causing storing said qualified transaction data in a database;
computer readable program code means for causing analyzing said qualified transaction data using a calculation means to determine a balance of a first participant's qualified transactions during a designated time period;
computer readable program code means for calculating a refund amount if said balance is positive; and
computer readable program code means for causing outputting said refund amount.

9. A method of facilitating commercial transactions over a computer network comprising the steps of:
receiving qualified transaction data, wherein said qualified transaction data regards an exchange of products between a first participant and a second participant, and said first participant and said second participant are members of a currency/barter system;
storing said qualified transaction data in a database;
analyzing said qualified transaction data using a calculation means to determine a balance of said first participant's qualified transactions during a designated time period, wherein said balance is equal to the difference of said first participant's qualified transaction sales less said first participant's qualified transaction purchases;
calculating a refund amount if said balance is positive; and
outputting said refund amount
